(19) United States
(12) Patent Application Publication
(10) Pub. No.: US 2013/0200230 A1
(43) Pub. Date: Aug. 8, 2013

(54) ADJUSTABLE STEP LADDER PAINT BUCKET HOLDER

(71) Applicant: Carl Christiansen, Lompoc, CA (US)

(72) Inventor: Carl Christiansen, Lompoc, CA (US)

(21) Appl. No.: 13/369,127

(22) Filed: Feb. 8, 2012

(51) Int. Cl. E06C 7/14

(52) U.S. Cl. 248/211

(57) ABSTRACT

An adjustable step ladder paint bucket holder incorporates a support plate with an angled grasping flange to be secured to a step ladder top step. An adjustable can bottom support extends from the support plate and adjustable rim supports are attached to the support plate to tangentially receive the circumference of the can. An adjustable hook receives a handle on the can to secure the can to the holder.

### BACKGROUND INFORMATION

1. Field

Embodiments of the disclosure relate generally to the field of paint bucket holders and more particularly to a paint bucket holder for use with a step ladder having an adjustable circumferential support for the bucket, a top step engagement plate, an adjustable bucket bail securing system and an adjustable bucket bottom holder.

2. Background

Step ladders are most frequently employed by painting professionals and “do it yourselfers” alike for interior painting projects. While step ladders often incorporate a shelf on which a paint can may be placed, there is no convenient method to secure the can to the shelf. Paint cans are of significantly differing sizes.

It is therefore desirable to provide a paint can holder which may be adjusted for and secured to a top step of a step ladder and adjusted for the size of a paint can. it is further desirable that the holder support a paint can from the bottom and circumference and the holder provide for securing the can to the holder.

### SUMMARY

Embodiments disclosed herein provide an adjustable step ladder paint bucket holder incorporating a support plate with an angled grasping flange to be secured to a step ladder top step. An adjustable can bottom support extends from the support plate and adjustable rim supports are attached to the support plate to tangentially receive the circumference of the can. An adjustable hook receives a handle on the can to secure the can to the holder.

The features, functions, and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

FIG. 1 is a top isometric view of the holder;

FIG. 2 a bottom isometric view of the holder of FIG. 1;

FIG. 3 is a top view of the holder of FIG. 1;

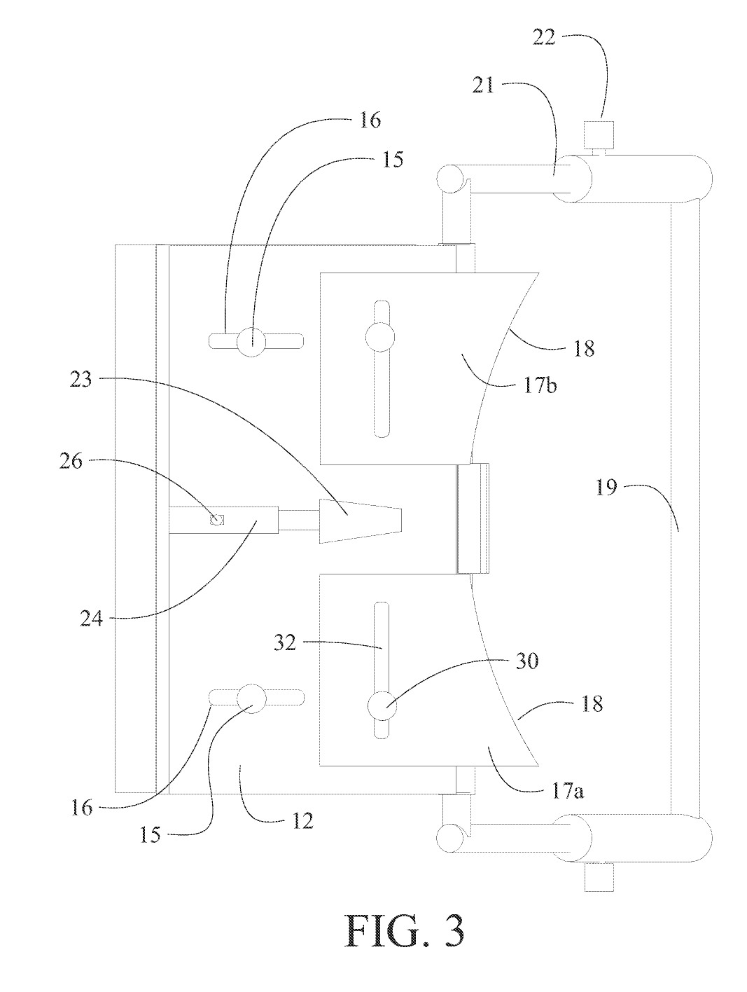

FIG. 4 is a side view of the holder shown in FIG. 1;

FIG. 5 is a front view of the holder shown in FIG. 1

FIG. 6 is a top isometric view of the holder with a paint supported with the adjustable rim plates, bottom support and can bail;

FIG. 7 is a top view of the holder with the can as shown in FIG. 6.

FIG. 8 is a top isometric view of the holder with a second smaller paint can supported with the adjustable rim plates, bottom support and can bail;

FIG. 9 is a top; view of the holder the can as shown in FIG. 8;

FIG. 10 is a side view of a first alternative embodiment of the holder; and,

FIG. 11 is a side view of a second alternative embodiment of the holder.

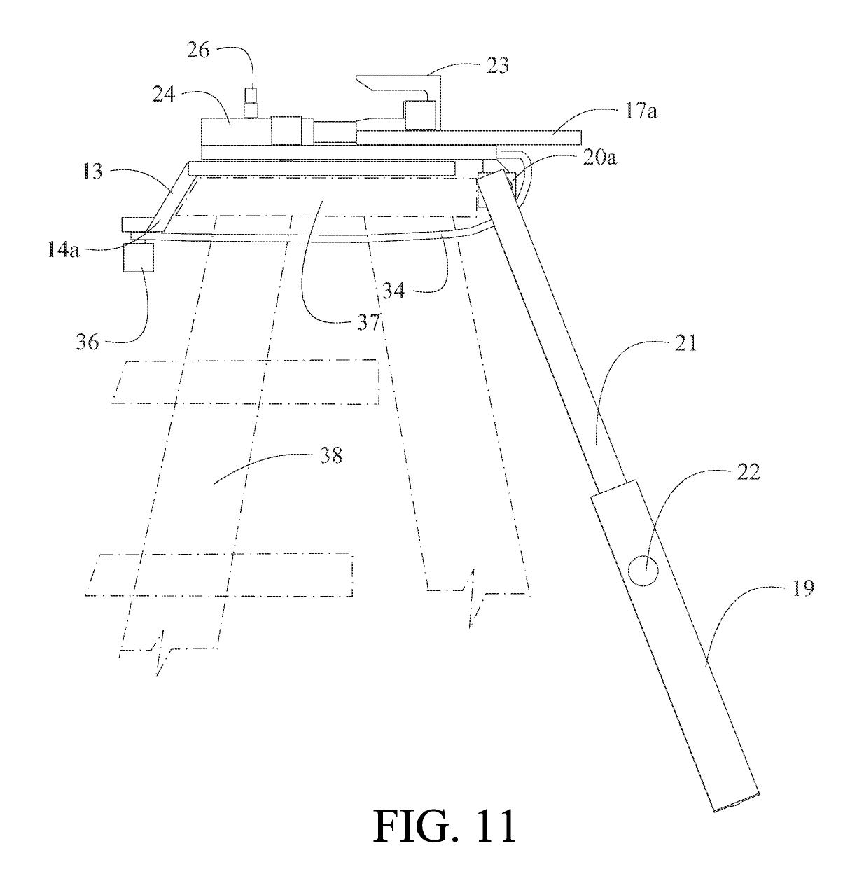

### DETAILED DESCRIPTION

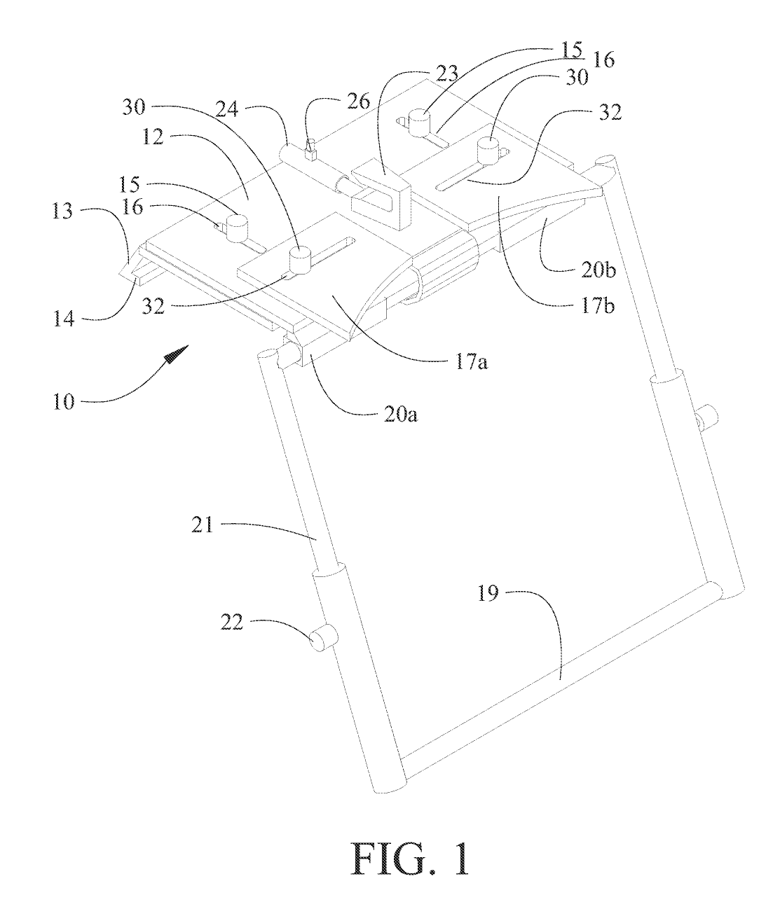

Embodiments disclosed herein provide a paint can support which is removably attachable to the top step of a step ladder. Referring to the drawings, FIG. 1 shows an embodiment of the paint bucket holder 10 having a support plate 12 which is sized to rest on the top surface of a step ladder top shelf. An angled grasping flange 13 depends from and is laterally adjustable from the support plate to engage a front flange on the step ladder top step with a hook 14 received under the ladder step front flange. Jam screws 15 inserted through slots 16 secure the support plate and grasping flange in relative alignment. The slots 16 are aligned for lateral expansion/contraction of the support plate and grasping flange to accommodate steps of varying width.

Two adjustable rim plates 17a and 17b are mounted to the support plate. The rim plates have a front surface 18 profiled (in the embodiment shown with a substantially circular radius) to receive a cylindrical side surface of a paint can as will be shown and described in greater detail subsequently. A bottom support 19 is pivotally mounted to the support plate with bearing blocks 20a and 20b to engage the bottom of the supported paint can. The bottom support 19 has telescoping sides 21 which are adjustable with jam nuts 22 to accommodate cans of different heights.

A hook 23 receives the handle of the can to further secure the can to the holder and is telescopically adjustable through a bore in receiving tube 24, A securing jam screw 26 fixes the position of the hook in the receiving tube.

The rim plates 17a and 17b are laterally adjustable with jam screws 30 engaging slots 32. A single jam screw may be employed in each rim plate to allow rotation of the plate as well as translation along the slot. In alternative embodiments two jam screws may be employed in each slot for fixed linear movement along the slot direction. The slots are shown oriented for perpendicular movement in such an embodiment. However, in alternative embodiments, the slots may be angled for two dimensional adjustment with two jam nuts along the line of the slot.

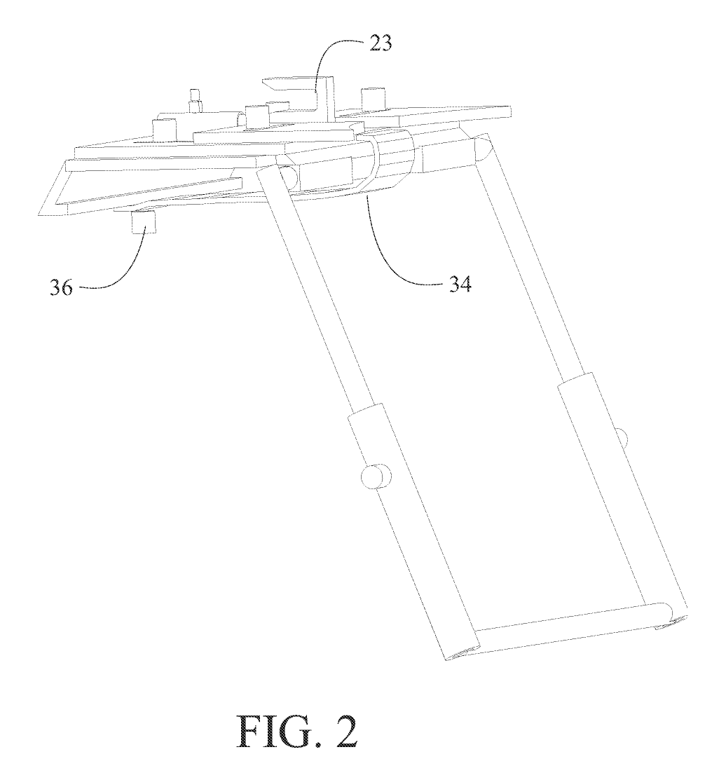

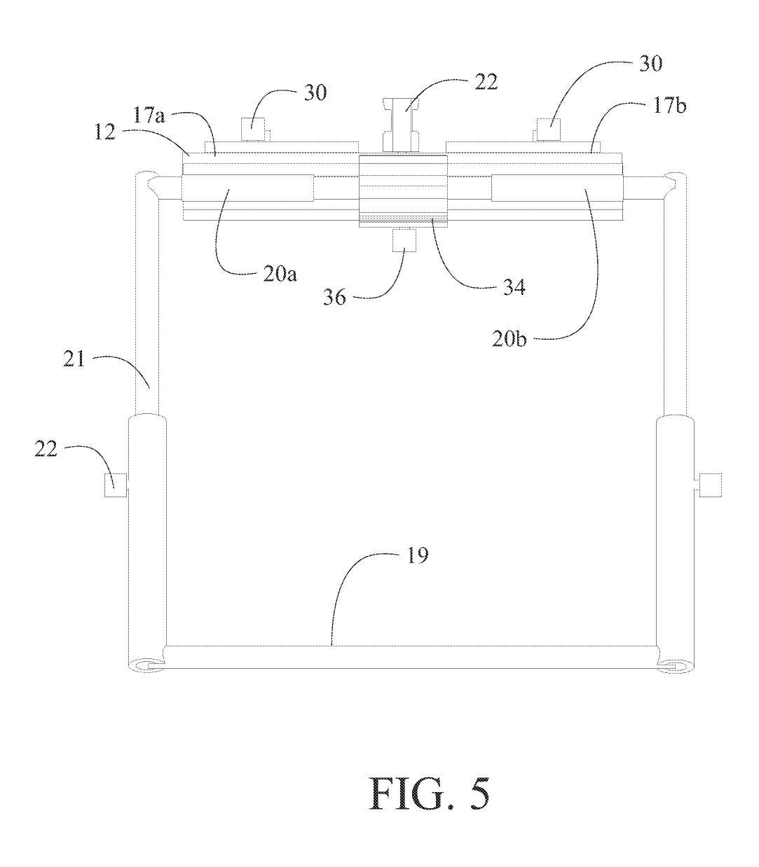

As best seen in FIGS. 2, 4 and 5, a securing strap 34 depends from the front of the support plate to pass under the top step of the step ladder and is secured to the angled grasping flange 14 with a fastener 36. In alternative embodiments a buckle or ratchet fastener may be employed for tightening of the strap under the step. In other alternative embodiments, a metal bail may replace the strap 34.

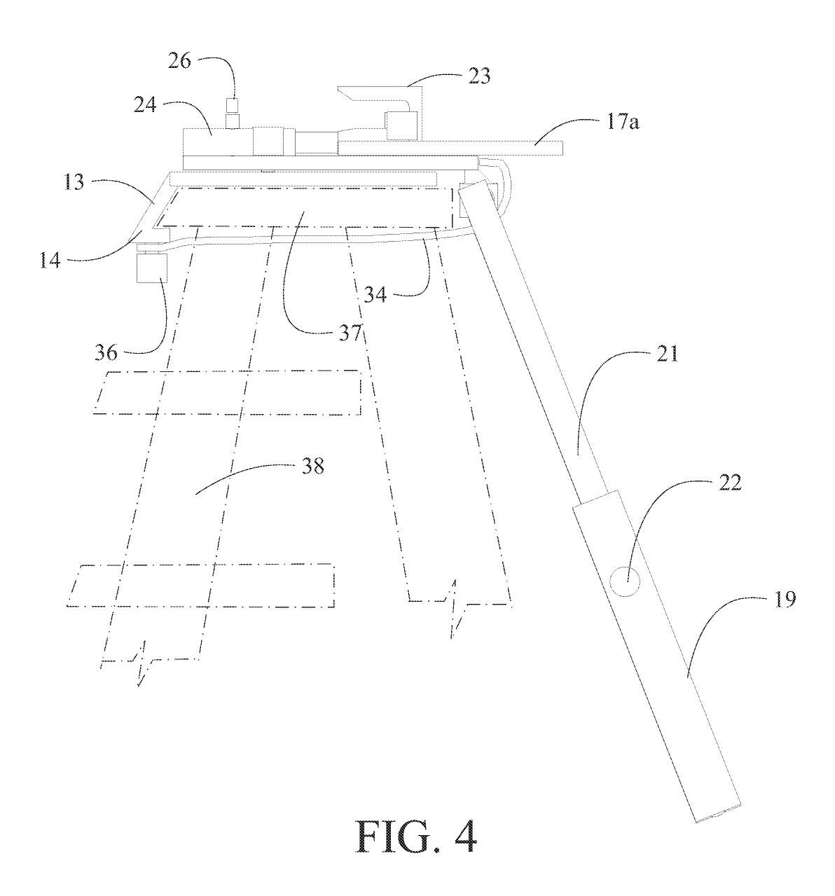

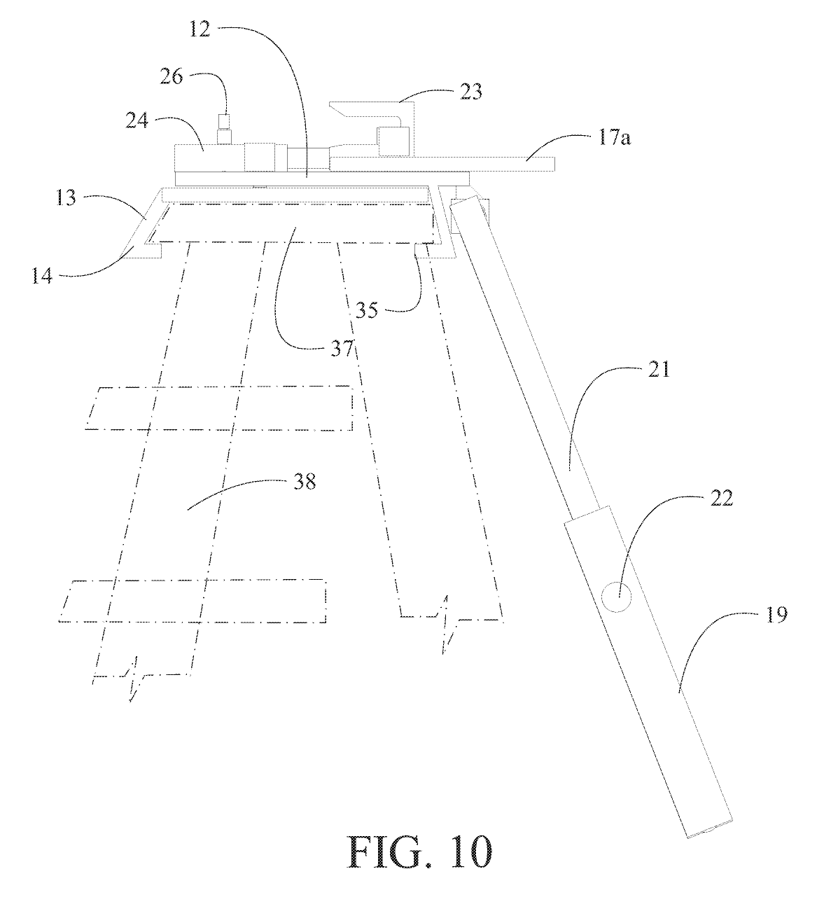

As seen in FIG. 4, the angled grasping flange 13 rests on a top step 37 of a step ladder 38, shown in phantom. The hook 14 is received under the bottom front edge of the top step and the strap 34 is wrapped under the step and secured with fastener 36. Adjustment of the width of the holder 10 to accommodate the step is accomplished by loosening the jam nuts 15 and sliding support plate 12 and flange 13 along slots 16 to elongate or retract the holder and then tightening the jam nuts. In alternative embodiments second hook 35 extending downward from the support plate 12 opposite the hook 14 extending downward from the angled grasping flange 13 is employed to grasp a front edge of the step 37 to replace the strap 34 as shown in FIG. 10, in an additional alternative embodiment, the hook 14 extending from the angled grasping flange 13 is deleted allowing the grasping flange to terminate in a depending element 14a with merely an angled edge. This allows the holder to be used with any thickness of top step on the step ladder with the adjustment of the support plate 12 and angled grasping flange 13 may be adjusted to engage the top step 37 of the ladder between the angled edge 14a and bearing blocks 20a and 20b thereby preventing forward and backward movement while the strap 34 prevents lifting of the holder off the step. While shown as angled in the embodiments of the drawings to accommodate an angled front face of the top step of the step ladder, the depending element 14a of the grasping flange may be substantially perpendicular to the support plate

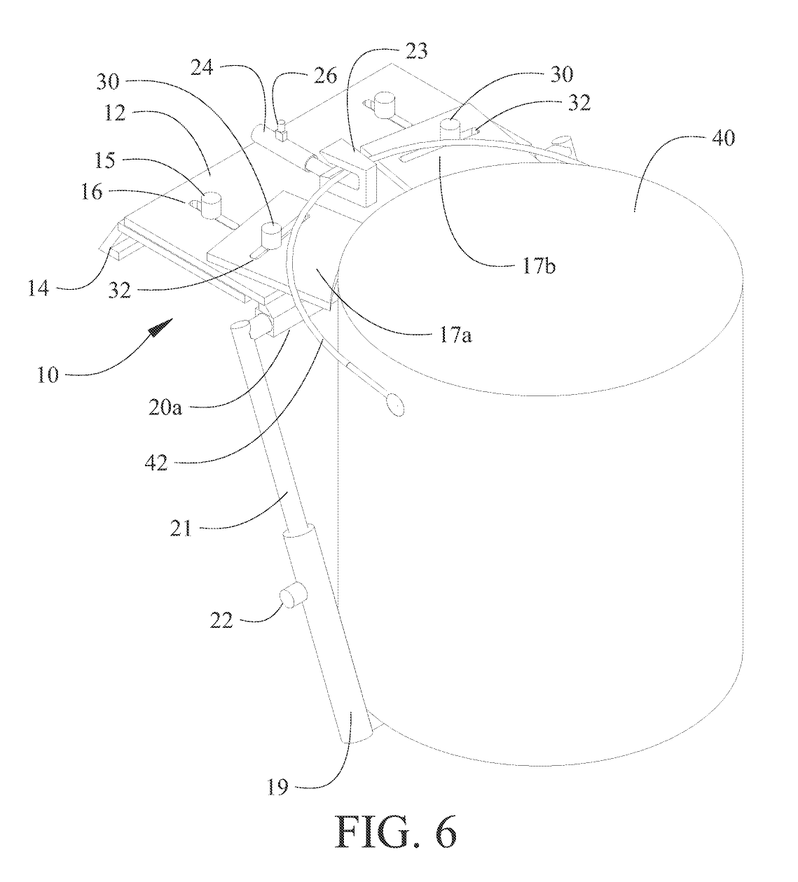

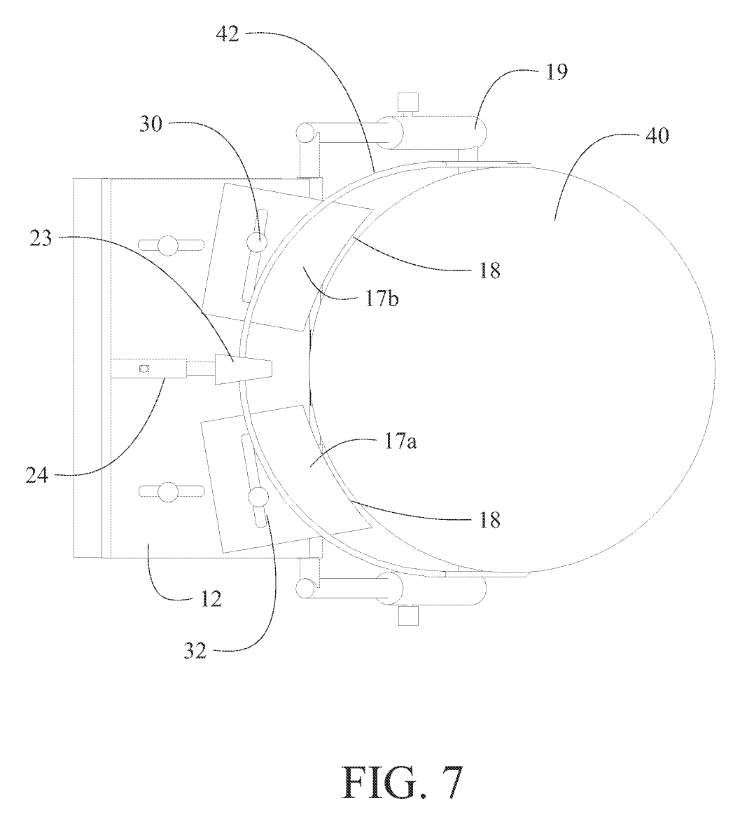

Once secured to the step, the holder may accommodate paint cans of various sizes. As shown in FIGS. 6 and 7 for a first can 40, bottom support 19 rotates in bearing blocks 20a and 20b to receive and support the can bottom, Telescoping sides 21 are adjusted for length using jam nuts 22. Can handle 42 is received in hook 23 which is adjusted in receiving tube 24 using jam nut 26 to firmly engage the handle, Rim plates 17a and 17b are adjusted laterally and rotated to most nearly match the can circumference by loosening jam nuts 30 and sliding the plates along slots 32 and/or rotating about jam nuts 30. Front surface 18 on the rim plates tangentially engages the circumference of the paint can (shown slightly displaced from the can surface in the drawing for clarity). The can is supported from the bottom by the bottom support, and the sides by the rim plates and secured in place using hook 23 engaging the can handle.

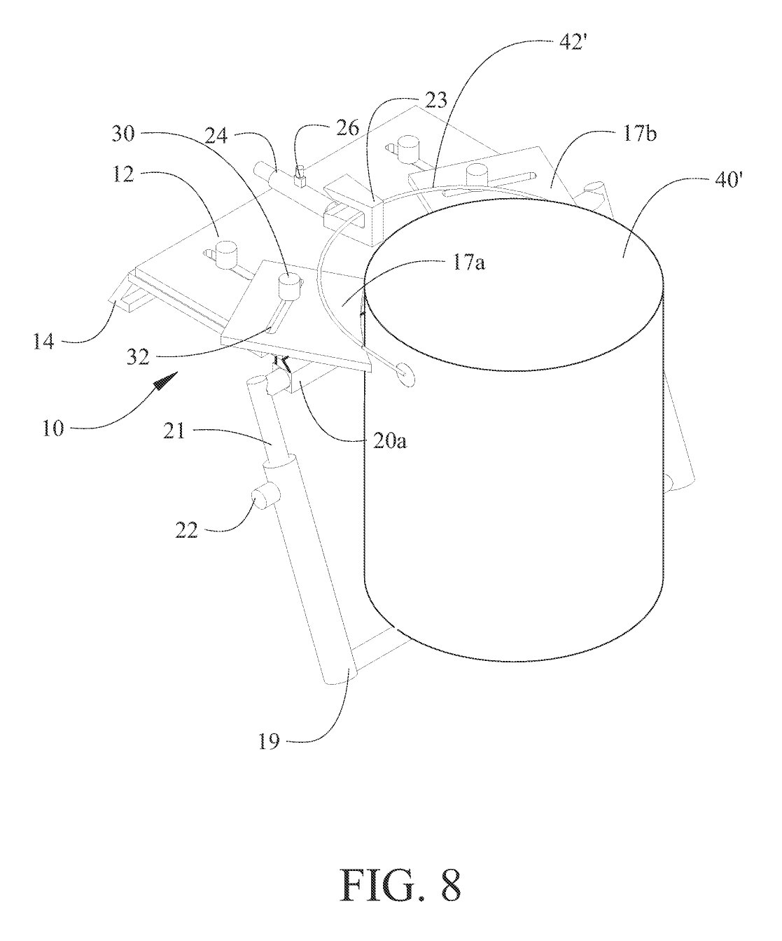

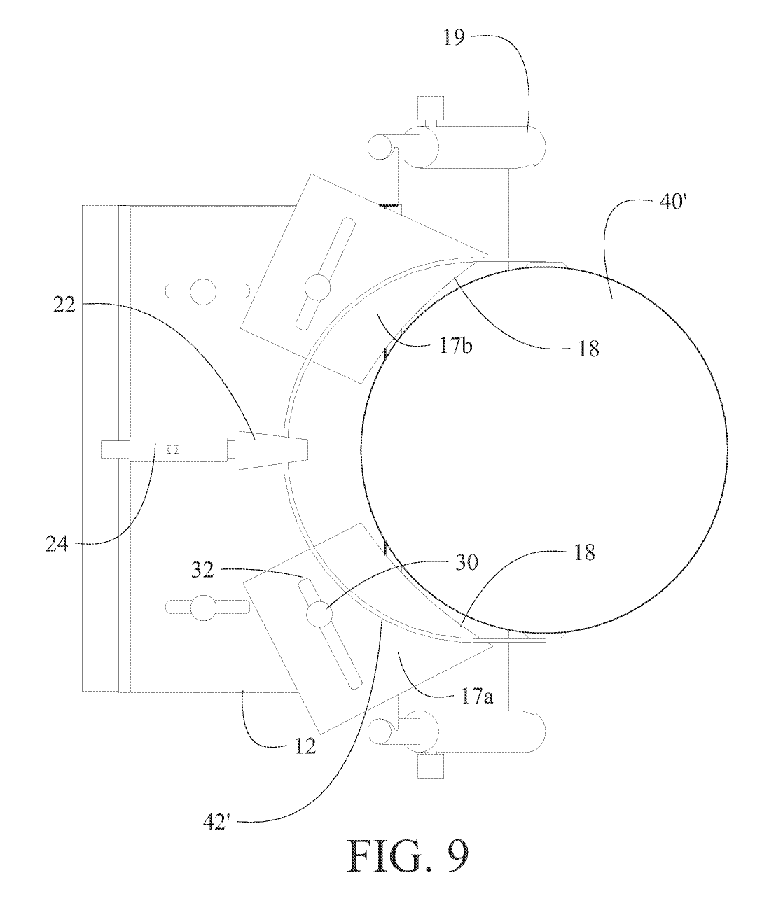

As shown in FIGS. 8 and 9, a second can 40′ of smaller size is accommodated by the holder by retracting the telescoping sides 21 of the bottom support 19 to fit the smaller height of the can, adjusting the rim plates 17a and 17b for the smaller diameter of the can and retracting the hook 23 into receiving tube. As shown in FIG. 9, while front surface 18 of the rim plates does not identically match the circumference of the can, tangential contact of the adjusted plates provides firm support for the can when brought into contact by tension on the can handle by the hook 23.

Having now described, various embodiments of the disclosure in detail as required by the patent statutes, those skilled in the art will recognize modifications and substitutions to the specific embodiments disclosed herein. Such modifications are within the scope and intent of the present disclosure as defined in the following claims.

What is claimed is:

1. An adjustable step ladder paint bucket bolder comprising:
a support plate with a grasping flange to be secured to a step ladder top step;
an adjustable can bottom support extending from the support plate;
adjustable rim supports attached to the support plate; and,
an adjustable hook to receive a handle on the can.

2. The adjustable step ladder paint bucket holder as defined in claim 1 further comprising:
a securing strap attached to a forward edge of the support plate and extending under the top step of the ladder and secured by a fastener on the grasping flange.

3. The adjustable step ladder paint bucket holder as defined in claim 1 wherein the support plate and grasping flange are adjustable to accommodate varying width of the step ladder top step.

4. The adjustable step ladder paint bucket holder as defined in claim 3 wherein the support plate is attached to the grasping flange by first jam nuts received through slots aligned for lateral adjustment of the support plate and angled grasping flange.

5. The adjustable step ladder paint bucket holder as defined in claim 1 wherein the rim supports each contain a slot through which a second jam nut is received for attachment to the support plate.

6. The adjustable step ladder paint bucket holder as defined in claim 5 wherein the rim supports are rotatable about the jam nuts and translatable along the slots.

7. The adjustable step ladder paint bucket holder as defined in claim 1 wherein the hook is retractable through a receiving tube for adjustment to accommodate the can handle.

8. The adjustable step ladder paint bucket holder as defined in claim 1 wherein the bottom support is pivotally attached to the support plate with bearing blocks.

9. The adjustable step ladder paint bucket holder as defined in claim 1 wherein the bottom support is telescopically adjustable for can length.

10. The adjustable step ladder paint bucket holder as defined in claim 9 wherein telescopic length of the bottom support is secured with third jam nuts.

11. The adjustable step ladder paint bucket holder as defined in claim 4 wherein the grasping flange incorporates a depending element with a hook to receive the step ladder top step.

12. The adjustable step ladder paint bucket holder as defined in claim 4 wherein the grasping flange incorporates an angled depending element to be received on an angled front face of the step ladder top step.

13. An adjustable step ladder paint bucket holder comprising:
a support plate with an adjustable angled grasping flange to be secured to a step ladder top step, said support plate support plate attached to the angled grasping flange by first jam nuts received through slots aligned for lateral adjustment of the support plate and angled grasping flange to accommodate varying width of the step ladder top step;
an adjustable can bottom support telescopically adjustable for can length and pivotally extending from and attached to the support plate with bearing blocks;
adjustable rim supports each containing a slot through which a second jam nut is received for attachment to the support plate, said rim supports rotatable about the jam nuts and translatable along the slots;
an adjustable hook to receive a handle on the can, said hook retractable through a receiving tube attached to the support plate for adjustment to accommodate the can handle; and,
a securing strap attached to a forward edge of the support plate and extending under the top step of the ladder and secured by a fastener on the angled grasping flange.
